(19) United States
(12) Patent Application Publication
(10) Pub. No.: US 2006/0231581 A1
(43) Pub. Date: Oct. 19, 2006

(54) Lifting and carrying device for motorcycles and other objects

(76) Inventor: Scott R. Jones, Boise, ID (US)

Correspondence Address: PEDERSEN & COMPANY, PLLC, P.O. BOX 2666, BOISE, ID, 83701, US

(21) Appl. No.: 11/109,199

(22) Filed: Apr. 18, 2005

(51) Int. Cl. B60R 9/00

(52) U.S. Cl. 224/403

(57) ABSTRACT

A device is used to lift and carry a motorcycle, scooter, other preferably-two-wheeled vehicle, or other object(s) on a transport vehicle such a pick-up truck, truck, or utility vehicle. A rail or other holder assembly on the lifting and carrying device is moveable between two operative positions, a lowered position generally at ground level and a raised position at a level on the transport vehicle that is appropriate for travel. The rail or other holder assembly is moved between the lowered and raised positions preferably by a lever system that is typically operable by one person. The preferred lever system maintains a rail assembly, for motorcycles or other two-wheeled vehicles, generally parallel to the ground throughout the lift from the lowered position to the raised position. When in the raised position, the rail assembly, including its load, preferably has a center of gravity located so as to maintain the rail assembly in the raised position.

### BACKGROUND OF THE INVENTION

### Field of the Invention

The present invention relates generally to a device for lifting and carrying an object on an outer surface of a vehicle, and in a preferred embodiment, a device the may be attached to a conventional vehicle receiver hitch and used to lift and carry a motorcycle or other two-wheeled vehicle.

### SUMMARY OF THE INVENTION

The present invention relates to a lifting and carrying device for transporting a motorcycle, scooter, other two-wheeled vehicle, or other object(s) as desired, on a transport vehicle such as a pick-up truck, truck, or utility vehicle. A rail or other holder assembly on the device is moveable between two operative positions, a lowered position generally at ground level and a raised position at a level on the transport vehicle that is appropriate for travel. The rail or other holder assembly is moved between the lowered and raised positions preferably by a lever system that is typically operable by one person.

The preferred lifting and carrying device may be connected to a conventional receiver hitch, and comprises a rail assembly configured to receive a motorcycle or other two-wheeled vehicle. The preferred lever system raises the rail assembly in “one pull” and maintains the rail assembly generally parallel to the ground throughout the lift from lowered position to raised position. A portion of the preferred lever system may pivot “up and over” to a vertical orientation and then a past-vertical orientation, while keeping the rail assembly generally parallel to the ground. The lever system portion is retained in the past-vertical position, by the weight of the rail assembly and the vehicle thereon, until the operator intentionally lowers the device by pivoting the lever assembly in the opposite direction. A latch or other lock also may be used to ensure that the lever system does not pivot by accident, or due to tampering, in said opposite direction to lower the rail assembly and vehicle thereon.

### BRIEF DESCRIPTION OF THE DRAWINGS

FIG. 1 is a side perspective view of one embodiment of the invented two-wheeled lifting and carrying device attached to a transport vehicle and holding a motorcycle in a lowered position.

FIG. 2 is a side perspective view of the embodiment shown in FIG. 1, with the lifting and carrying device and motorcycle in a raised position.

FIG. 3 is a rear perspective view of the embodiment shown in FIGS. 1 and 2, with the lifting and carrying device and motorcycle in a raised position, and the handle lever removed for traveling.

FIG. 4 is a rear perspective view of the embodiment of FIGS. 1-3, removed from the transport vehicle, with the device in a lowered position.

FIG. 5 is a front perspective view of the embodiment of FIGS. 1-4, with the device in a lowered position as it is in FIG. 4.

FIG. 6 is a rear perspective view of the embodiment shown in FIGS. 1-5, wherein the device is in a partially-raised position about half way between the lowered position and the raised position.

FIG. 7 is a rear view of the embodiment shown in FIGS. 1-6, wherein the device is in the partially-raised position as in FIG. 6.

FIG. 8 is a front perspective view of the embodiment shown in FIGS. 1-7, with the device in the partially-raised position as in FIGS. 6 and 7.

FIG. 9 is a rear perspective view of the embodiment shown in FIGS. 1-8, wherein the device is in a fully raised position.

FIG. 10 is a front perspective view of the embodiment shown in FIGS. 1-9, wherein the device is in the fully raised position as in FIG. 9.

FIG. 11 is a rear, exploded view of the embodiment shown in FIGS. 1-10.

FIG. 12 is a side, exploded view of the embodiment shown in FIGS. 1-11.

FIG. 13A is a schematic view of the lever system of the preferred embodiment.

FIG. 13B is a schematic view of a lever system without an orientation/guide member.

FIG. 13C is a schematic view of a lever system without an orientation/guide member but with a lower pin sliding in a slot of a lift plate.

FIGS. 13D and 13E are schematic views of a lever system with a chain linkage as a orientation/guide member.

### DESCRIPTION OF THE PREFERRED EMBODIMENTS

Referring to the Figures, there are shown several, but not the only, embodiments of the lifting and carrying device, which is configured for transport of a two-wheeled vehicle, such as a motorcycle, on a pick-up truck or other vehicle. The preferred embodiment of the lifting and carrying device, hereafter called “the device” or the “lift device,” is configured to connect to a conventional hitch receiver, such as the square tubular receiver provided on many pick-up trucks and other towing vehicles. Many of these receiver hitches are rated for 500 pounds, and, the preferred embodiment (which is typically about 150 pounds or less), holding a two-wheeled vehicle such as a smaller motorcycle, a scooter, or a bicycle (which are typically less than 300 pounds) preferably will be within that weight limit. The lift device may be beneficial to many motorcyclists, dirt-bikers, hunters, ranchers, farmers, and other recreationists or workers who want their two-wheeled vehicle to be easily and safely transportable without requiring an additional person to help them lift or push the two-wheeled vehicle onto a rack or up a ramp. The preferred lift device 10 carries the two-wheeled vehicle or other object near and above the transport vehicle's bumper, but preferably not in the truck bed.

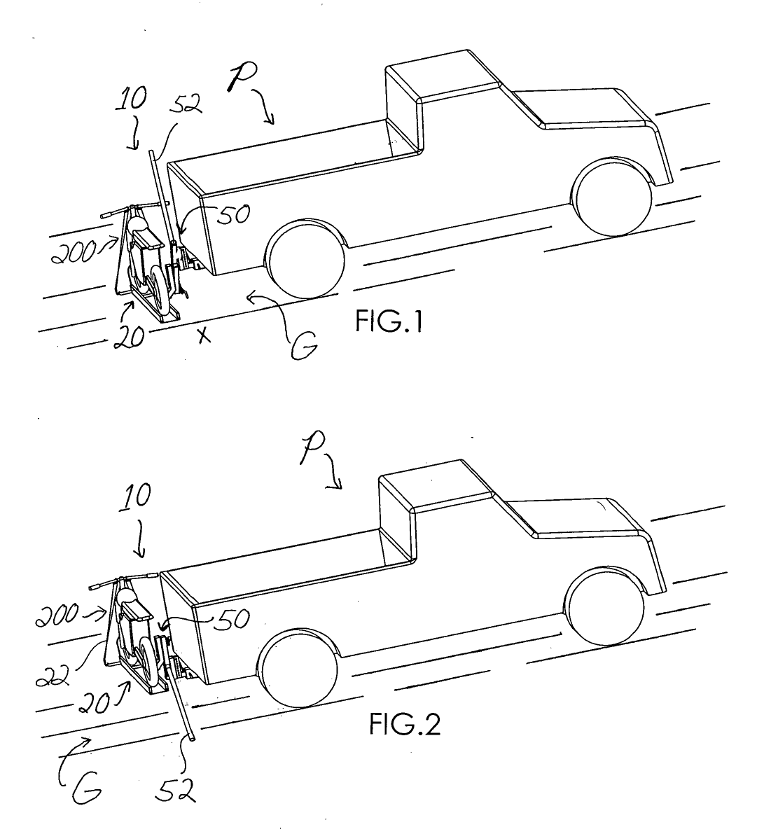

The preferred lift device 10 is shown attached to a pick-up truck P in FIGS. 1-3. Although many users of the invention will attach it to a pick-up truck, the invention may be attached to many other “transport” vehicles, such as larger trucks, utility vehicles, busses, construction equipment, and any vehicle capable of safely carrying the device and its load. Typically, but not necessarily, the transport vehicle will have four or more wheels, on two or more axles.

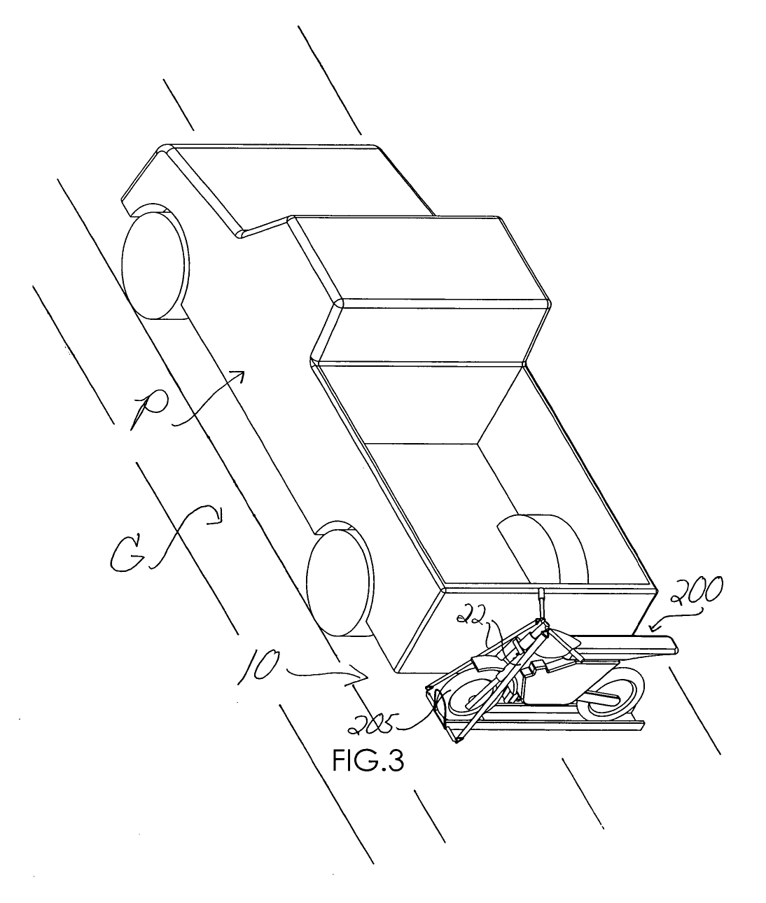

In FIG. 1, the motorcycle 12 has been rolled onto the rail assembly 20, which is still on the ground G, and then secured with cords 22. In FIG. 2, the rail assembly 20 has been lifted to the raised position by the lever assembly 50, as may be noted by the position of the handle lever 52. FIG. 3 is another view of the lift device 10 in the raised position, wherein the lever handle 52 has been removed and stowed, for transport of the motorcycle.

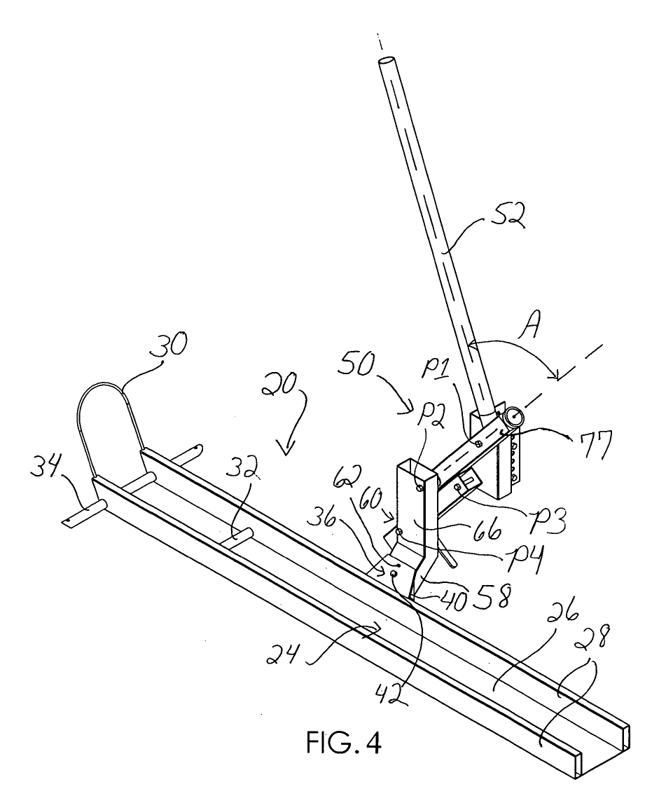

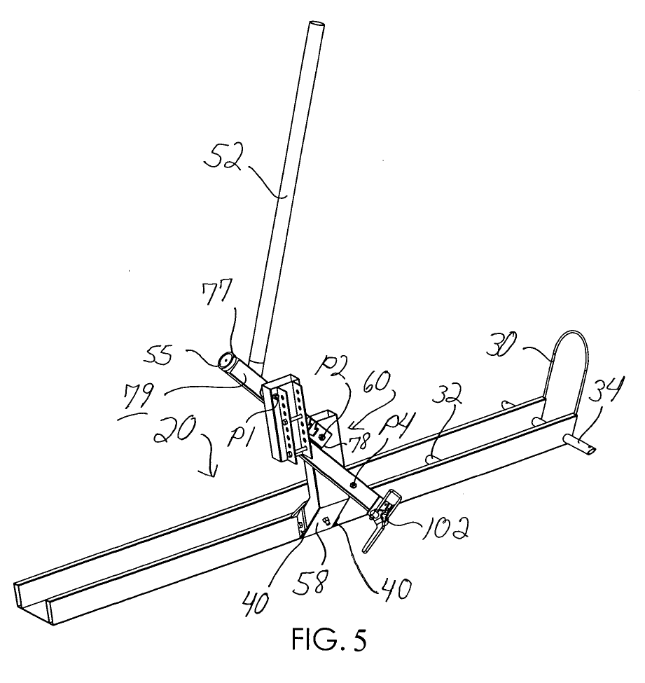

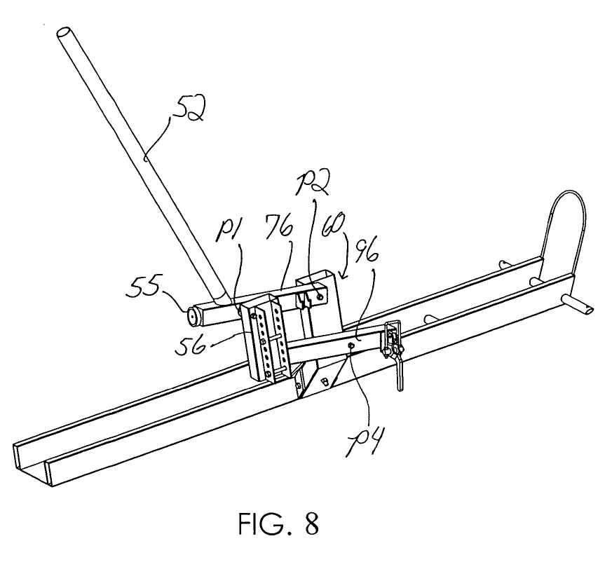

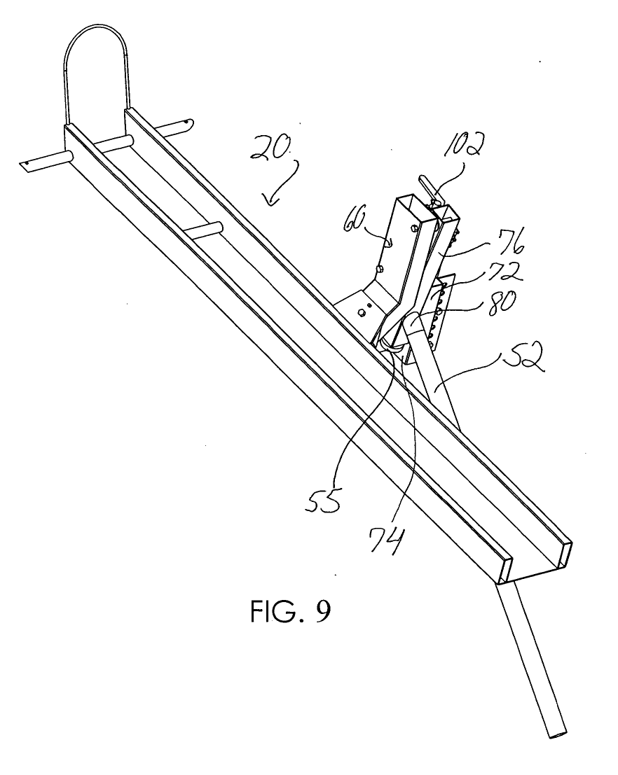

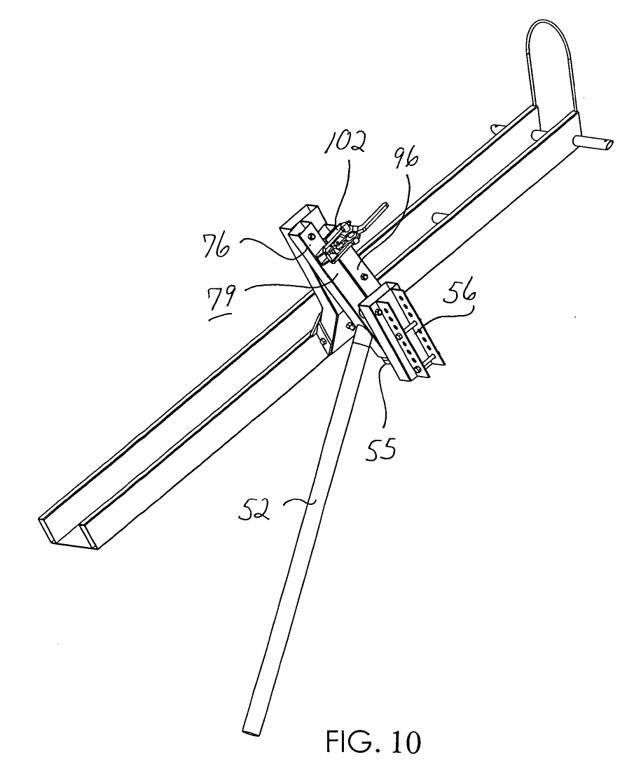

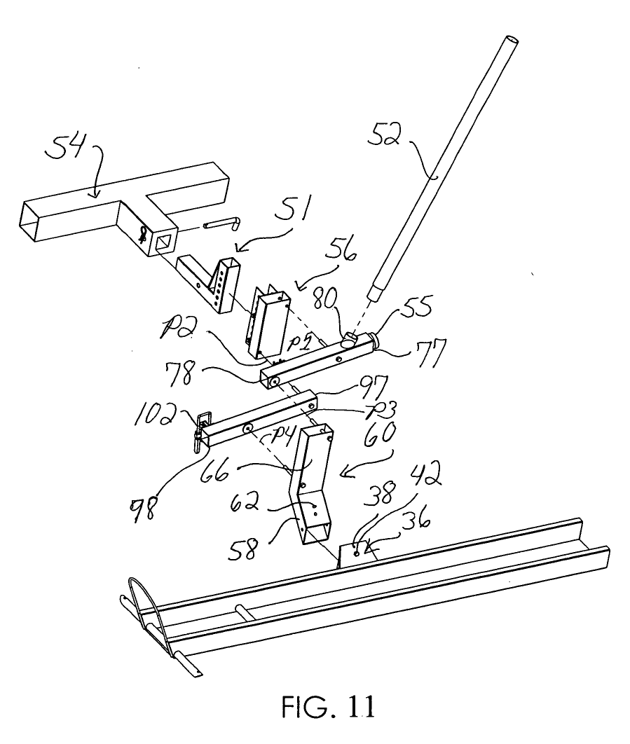

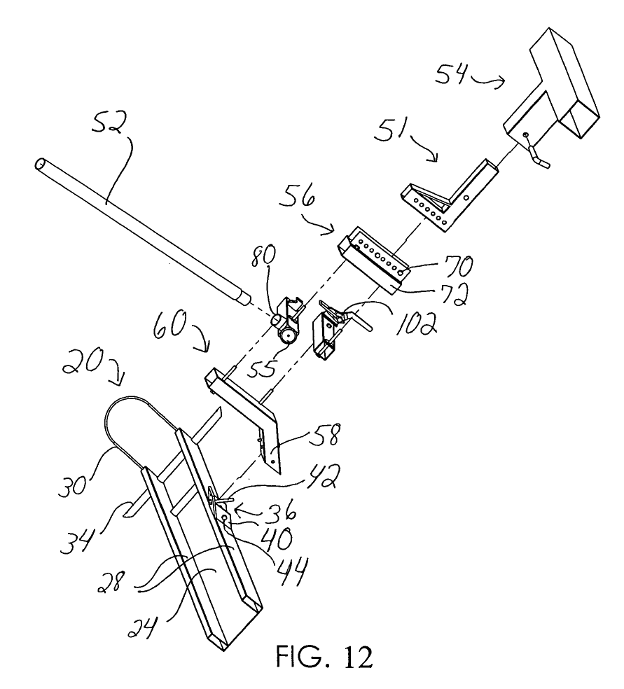

FIGS. 4-10 illustrate the preferred lift device 10, detached from the transport vehicle, in a fully lowered position (FIGS. 4-5), in a partially-raised position (FIGS. 6-8), and in fully-raised position (FIGS. 9 and 10). FIGS. 11 and 12 illustrate the pieces-parts of the preferred embodiment, which is useful for understanding the following discussion.

The device is readied for use by installing its male hitch member 51 into the hitch receiver 54 of the transport vehicle (P) (see FIGS. 6, 11 and 12). Adjustable bracket 56 removably and adjustably connects to the male hitch member 51, so that the bracket 56 may be raised and lowered relative to the receiver 54 to account for differences in the level of various vehicles' receivers 54 above the ground. This way, for a particular transport vehicle and its receiver 54, the bracket 56 may be adjusted relative to the receiver 54 to position the device so that, when the lever assembly 50 is operated to lower the rail assembly 20, the rail 24 rests on the ground (that is, ground, road, floor, or other horizontal surface from which the motorcycle is to be loaded, but hereafter called “ground”).

The rail assembly 20 is attached to the lever assembly 50, preferably by hanging the rail assembly 20 on the angled end 58 of rail mount 60. Rail assembly 20 has a mounting bracket 36, which extends over the angled end 58, and which includes hole 38 that receives peg 62. The rail and side panels 40 abut against the end and side surfaces, respectively, of the angled end 58, so that, once the bracket 36 is hung on the peg 62, the rail assembly will not swing or pivot on the angled end 58 and floor 26 remains in a plane perpendicular to the main body 66 of the rail mount 60 and also parallel to the ground. The rail assembly will hang there otherwise unsupported, so that the user may remove his hands to continue assembling the device. The user typically will then bolt the bracket 36 to the angled end 58 of the rail mount 60 with a bolt 42, near and generally parallel to the peg 62, and will also insert a pin 44 through the side panels 40 of the bracket 36 and the side surfaces of the angled end 58. Thus, the rail assembly 20 is attached to the lever assembly 50 by a plurality of fasteners.

Once the device 10 is installed in the receiver 54, and the rail assembly is hung on the lever assembly 50, the rail assembly 20 may be lowered to place the rail 24 on the ground, as shown in FIGS. 4 and 5. The procedure for lowering the rail assembly is the reverse of lifting the rail assembly, which is discussed in detail in later paragraphs.

The motorcycle 200 or other two-wheeled vehicle (hereafter, referred to only as the “motorcycle”, for convenience) is rolled onto the rail 24, typically by a single person rolling it along the floor 26 in between the rail walls 28. The floor 26 is generally parallel to the ground and only a distance above the ground equal to the thickness of the floor material, and so it typically easy for the operator to push the motorcycle front wheel 205 up onto the floor 26 and all the way to the wheel retainer 30 at the end of the rail. The front wheel 205 rests between the wheel retainer 30 and the rear stop 32, and the motorcycle is strapped down by means of cords 22, so that the motorcycle is unlikely to move longitudinally on the rail assembly 20 unless intentionally removed by the user.

Optionally, other ways of retaining one or both motorcycles wheels on the rail may be used, including a wheel retainer and/or rear stop that are slidable, pivotal, or otherwise moveable along the rail in order to adjust the location at which the wheel(s) of the motorcycle are retained on the rail. An adjustable retainer or stop may help in balancing the motorcycle on the rail assembly so that the center of gravity of the motorcycle preferably lies in generally the same vertical plane as the center of gravity of the rail assembly.

The rail walls 28, in combination with the cords 22, prevent forward or rearward movement of the motorcycle off of the rail assembly. In general, “front” and “forward,” and “rear” and “rearward” mean toward the front and the rear of the transport vehicle, respectively, except in cases wherein a particular part of the motorcycle is being described (as in “front wheel” of the motorcycle). Also, “right” and “left” are in the direction of the right and left of the vehicle, respectively.

An important feature of the preferred device 10 is that the rail 24 and its floor 26 are maintained generally horizontal throughout use of the device 10. This is important particularly when the motorcycle is being loaded onto the rail assembly 20, because there is little, if any, extra effort required to load the motorcycle compared to normal rolling or pushing the motorcycle a few feet along the ground, and the user can typically do this by himself/herself.

Cords 22 may be anchored to the rail assembly near the outer ends of transverse anchor bar 34. Bar 34 extends out from both sides of the rail 24 near the wheel retainer 30, to provide a wider profile for cord attachment for increased motorcycle stabilization. The bar 34 is preferably removable from the rail 24, to narrow the profile of the rail assembly 20 for storage, for example, so that the rail may be slid into the truck bed without catching on other items and without taking up much room.

The lever assembly 50 preferably comprises the adjustable bracket 56, lift arm 76, orientation arm 96, and rail mount 60. Bracket 56 has perforated front flanges 70 for adjustable connection to the male hitch member 52, as discussed above, and also has rear portion 72. Rear portion 72 may be various shapes, but preferably has a generally flat rear surface or “plate 74.” Pivotally mounted on plate 74 are preferably two lever arms, which hereafter are called “lift arm” 76 and “orientation arm” 96, because of their main functions of raising, and maintaining the orientation, of the rail assembly 20, respectively.

Lift arm 76 is pivotally connected to plate 74 at a first pivot point P1, by a welded pin or other axle. Pivot point P1 is preferably near a right end 77 of lift arm 76. At or near its left end 78, lift arm 76 is pivotally connected to the main body 66 of rail mount 60 at pivot point P2. Pivot point P2 is at or near the top end and a right side of main body 66. The lift arm 76 pivots between the plate 74 and the main body 66, in other words, the plate 74 is in front of the lift arm 76 and the main body 66 is behind the arm 76.

Nearer to the right end 77 of lift arm 76 than the pivot point P1 is an attachment for lever handle 52. This attachment may be of various designs, but preferably comprises a detachable attachment such as an end of the handle 52 sliding into a sleeve 80 in a top side of the lift arm 76. The lever handle 52 is long relative to the lift arm, preferably about 3.5-4 feet, as a longer handle will provide greater leverage on the lift arm. In the lowered position, the lift arm 76 is generally diagonal, with its right end 77 higher than its left end 78, and the handle 52 extends at an angle A of about 20-60 degrees, and more preferably about 20-40 degrees from the lift arm, so that it extends upwards and to the left (see FIG. 4).

In use, lever handle 52 is used to pivot lift arm 76, in that the very long lever handle 52 provides substantial leverage on the arm 76. The lever handle 52 is preferably over three feet long, preferably in the range of 3-6 feet long, and most preferably 40-48 inches long. The handle lever 52 of the embodiment drawn in the Figures is 44 inches long. Embodiments for use with bicycles, however, have reduced lifting requirements, and may use a lever handle 52 of two feet or greater, for example. A user stands to the right side of the lever assembly (see X in FIG. 1), grasps the lever handle 52 and pulls it toward himself, that is, to the right in FIGS. 1, 4 and 7. The user pulls the lever handle 52 all the way to the right and down toward the ground in a single pull, and, in doing so, the lift arm pivots around pivot point P1, with the left end 78 swinging upwards and the right end 77 swinging downwards. Consequently, the rail mount 60 is lifted upwards by the lift arm 76, due to the connection between arm 76 and mount 60 at P2.

The combination of lift arm 76 and the lever handle 52 may be considered a single lever pivoting on a fulcrum at pivot point P1. The portion of the lift arm to the left of P1 (between pivot point P1 and P2) may be called a lift portion L, and the portion of the lift arm to the right of P1 plus the lever handle 52 may be called the handle portion H. In the preferred embodiment, the lever handle 52 is rigidly and fixedly attached to the lift arm 76 a few inches to the right of pivot point P1, and at an angle A to the lift arm 76, so that the user may easily and ergonomically reach the handle 52 and lift the rail assembly in a single pull. Thus, it may be said that the “single lever” preferably includes a bend or curve (angle A) in the handle portion. Also, it may be said that the connection of the handle lever 52 at sleeve 80 is one example of a “detachable joint” that allows an “angled part” of the handle portion H to be removed from the “aligned part” of the handle portion (wherein “aligned” here means aligned with the longitudinal axis of the lift portion). The bend or curve in the single lever could be at a location closer to, at, or farther from the fulcrum, as long as the length and shape of the lever are configured to provide sufficient leverage, preferably with a comfortable single pull of the lever by a standing person.

In embodiments wherein the device is attached to a conventional hitch on the rear end of a conventional transport vehicle, the lever handle 52 is preferably detachably fixed to the lift arm at an angle A, because the long lever handle 52 would otherwise hit the ground during the single pull. However, in embodiments wherein the spacing, size, or height of equipment is such that the user can easily move the handle 52 without the ground getting in the way, other angles might be used for the connection of the handle 52 to the lift arm 76, or, in some case, no angle may be necessary in connecting the handle 52 to the lift arm. In other words, the lever handle 52 may be described as an extension of, or elongated portion of the lever that lifts the rail assembly, with the angle and detachable connection between the lever handle 52 and the lift arm 76 being for convenience, ergonomics, and compact storage.

Orientation arm 96 is pivotally connected to the plate 74 and to the rail mount 60 in a similar manner to, and parallel to, lift arm 76. Orientation arm 96 is pivotally attached, at or near its right end 97, to plate 74 at pivot point P3. P3 is below and to the left of P1, so that P3 is generally near the lower, left corner of the plate 74 (diagonal to P1, which is in the upper, right corner of the plate 74). Orientation arm 96 is pivotally attached, nearer its left end 98, to the rail mount 60 at pivot point P4. P4 is below and to the left of P2, so that P4 is generally near the lower, left corner of the main body 66 of the rail mount (diagonal to P2, which is in the upper, right corner of the main body 66). The term “nearer its left end 98” indicates that P4 is “nearer its left end” than is P3, but that P4 is actually about in the middle of the length of the arm 96. This middle position results from the left end of arm 96 being extended, farther than is necessary for proper pivoting, in order to provide a length of arm for latching of the two arms together in the raised position. The latching system, shown in FIGS. 9 and 10, is discussed later in this Description.

As the user pulls the lever handle 52 to pivot lift arm 76 and lift the rail mount, the rail mount lifts the left end of the orientation arm 96, so that the orientation arm 96 pivots as well. The length of lift arm 76 and orientation arm 96, and the location and spacing of the pivot points P1, P2, P3, and P4, are designed so that the two arms (76, 96) stay parallel during their pivot/swing up to the raised position. One may note from the drawings that P2 and P4 are the same distance apart as P1 and P3, and P1 and P2 are the same distance apart as P3 and P4. This arm and pivot point configuration, and the resulting two parallel arms, serve to maintain the rail mount 60 in a vertical position, that is, parallel to the length of the plate 74 and generally perpendicular to the ground. This may be seen to best advantage by comparing the arms (76, 96) and rail mount 60 position in the lowered position (FIGS. 4 and 5), the partially-raised position (FIGS. 6-8), and in the raised position (FIGS. 6-8). Indeed, the arm and pivot point configuration dictates that the rail mount will stay vertical, thus maintaining the rail assembly in a horizontal orientation during the entire lifting process. As may be noted from the Figures, the preferred lever handle 52 starts at about a 11 o'clock position (viewed from the rear) when the device is in the lowered position, and swings all the way to about a 4 or 5 o'clock position when the device is in the raised position. Thus, the handle is pulled about 140-180 degrees by the user through the entire range of fully lowered to fully raised, and most preferably about 150-160 degrees. The angle of the connection between the lever handle 52 and the lift arm 76 will affect where the lever handle starts and finishes, and the inventor has found that this “about 11 o'clock to about 4 o'clock” single pull is comfortable and ergonomically feasible for most users.

When the two arms (76, 96) are at the top of their swing, they are vertical, with the left ends pointing straight upwards. Preferably, the arms (76, 96) continue to pivot a little distance further, to the extent that they go “past-vertical” to the position shown in FIGS. 9 and 10, wherein both arms (76, 96) are at about 5-20 degrees relative to vertical, and most preferably about 8-15 degrees relative to vertical. This pivoting past-vertical places the center of gravity, for the combination of the arms (76, 96) and the load they carry, at a point to the right of pivot points P1 and P3. Thus, once the user has leveraged the lever assembly 50 to this position, it will stay in this position when the user removes his hands from the device. This allows the user to leave the device in this position for some time, barring tampering or interference from another party, while the user performs other tasks without holding on to the lever handle 52. The lever handle 52 may be removed and stowed, which further inhibits unwanted or accidental movement of the lever assembly 50. Preferably, the “other tasks” include latching or otherwise locking the lever assembly in this position, by engaging latch 102 or other fasteners, pins, locks, or connectors to lock the lever assembly 50 in the raised position. Such locking allows the user to walk away from the vehicle and motorcycle, or to drive the vehicle away with motorcycle attached, without safety and security concerns.

The preferred latch 102 is a latching toggle clamp, which fastens the left end 98 of orientation arm 96 to the left end 78 of lift arm 76, so that they cannot separate from each other. Because the two arms (76, 96) must separate from each other during the pivoting process (either in the lifting process or the reverse lowering process), latch 102 prevents lowering of the device. The latch 102 may also be locked with a padlock, for further safety and security.

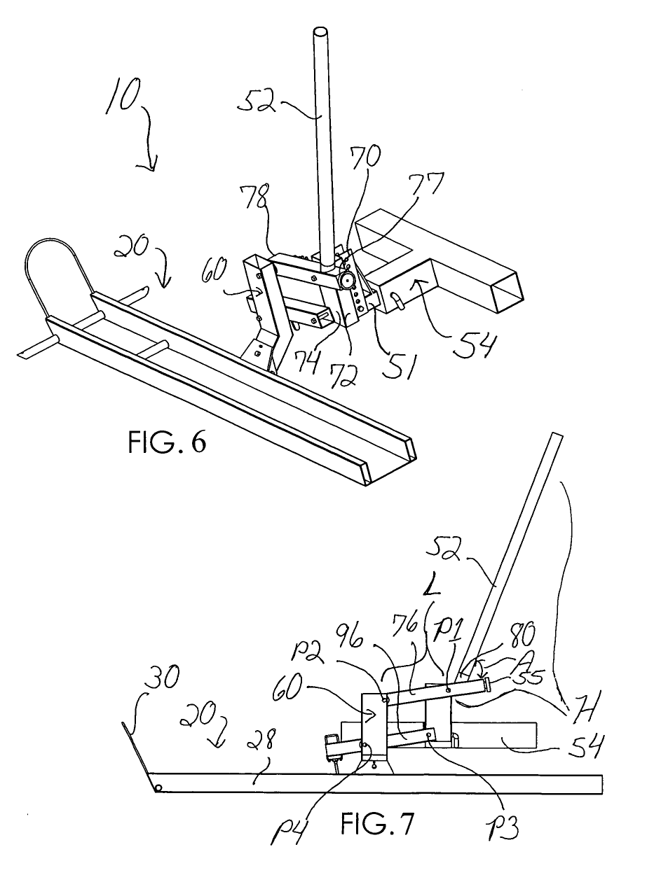

Additional structure may be added to optimize pivoting, strength, or motorcycle securement, for example, if necessary. For example, a roller 55 may be added to the right end 77 of the lift arm 76, in order to support the lift arm 76 against the plate 74 when the lift arm is pivoting to, and has reached, the raised position. See FIGS. 7-10. Roller 55 or other slidable, rollable, or other low-friction spacer may be used to fill the space between the right end 77 of the lift arm and the plate 74 when the right end 77. Preferably, the roller 55 extends from the front surface 79 of the lift arm a distance generally equal to the space between the lift arm and the plate 74 in the vicinity of the pivot point P1, which space is typically caused by structure or welding that mounts the axle of P2 in the bracket 56. This way, when lift arm 76 reaches the plate 74, the roller 55 rolls along the plate 74 and keeps the front surface 79 of the lift arm generally equidistant from the plate all along the length of the lift arm. Thus, during the lift, and especially during the prolonged time the lift arm 76 is typically in the raised position, the weight of the lever assembly, rail assembly, and motorcycle, is unlikely or unable to force the front surface 79 near right end 77 against the plate 74 to bend the pivot axle at P1 or cause other damage.

When the user wishes to lower the motorcycle for removal from the device 10, the opposite process is performed. Latch 102 is unlocked/unlatched, and the lever handle 52 is installed in the sleeve 80. As shown in FIGS. 2, 9 and 10, when the lever assembly 50 is in the raised assembly, installing the lever handle 52 results in the handle 52 extending downward and to the right. The user grasps the lever handle 52 and lifts it (clockwise in FIG. 9 and counterclockwise in FIG. 10) to pivot the arms (76, 96) to vertical, which requires some lifting strength on the part of the user, and then, as the left ends 78, 98 of the arms pivot down toward the ground by the force of gravity, the user may utilize the lever handle 52 as a “brake” to control the speed with which the rail assembly and motorcycle approach the ground. As in the raising process, the arms (76, 96) keep the rail 24 parallel to the ground, and, once the rail touches the ground, the motorcycle may be un-strapped and rolled off the open end of the rail 24.

The preferred lever assembly may be said to pivot and move in a plane parallel to the rear of the vehicle, for example, parallel to the tailgate. The lever assembly, and the entire device, preferably do not pivot or move in a plane transverse to the rear of the vehicle, that is, parallel to the length of the vehicle. In other words, the pivoting and movement of the preferred device is “side-to-side” and “up-and-down” relative to the transport vehicle, but not forward and backward.

Although the arms (76, 96) will reach a point in their pivoting downward (counterclockwise in FIG. 4) when they will impact each other and not pivot anymore, their pivoting is more preferably limited by the rail assembly reaching the ground. This way, when the rail assembly is lowered, the lever assembly and the vehicle's hitch are not holding the weight of the motorcycle. This is made convenient by the adjustable hitch bracket 56, which allows the ground to be the limit even for transport vehicles that are relatively high off the ground.

Although the above Description and the Drawings illustrate an embodiment wherein the user stands to the right of the device 10 and pulls the handle clockwise to raise the motorcycle, one may see that mirror image embodiments may be made wherein the user stands at the left of the device and pivots the lever assembly counterclockwise to raise the motorcycle. In other words, the use of “right”, “left”, “clockwise” and “counterclockwise” in this Description are only to describe the embodiments drawn and are not to limit all embodiments of the invention to having this particular orientation.

While the preferred lever assembly is shown and described above, other lever assemblies may be used. Preferably, the lever assemblies include a lever that is forced by a user to pivot on a fulcrum, lifting in a single pull a rail assembly holding a two-wheeled vehicle. Preferably, the lever comprises an extension at an angle to the main body of the lever that allows the user to stand beside the device and comfortably apply the force through the distance required to affect the lift. Preferably, the lifting assemblies also comprise an orientation arm or other guide member that guides, restrains, or otherwise controls the rail assembly to stay generally parallel to the ground.

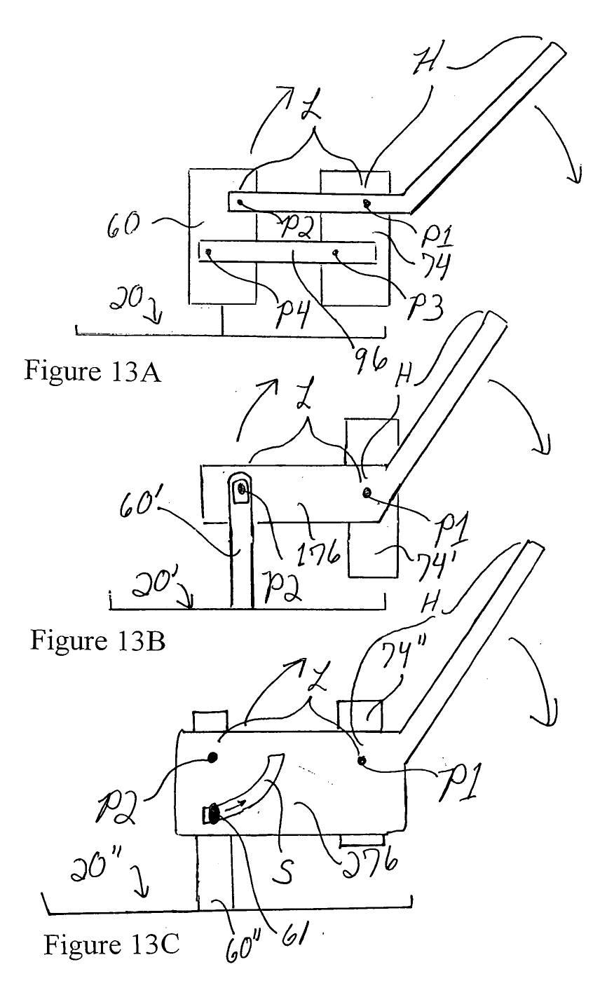

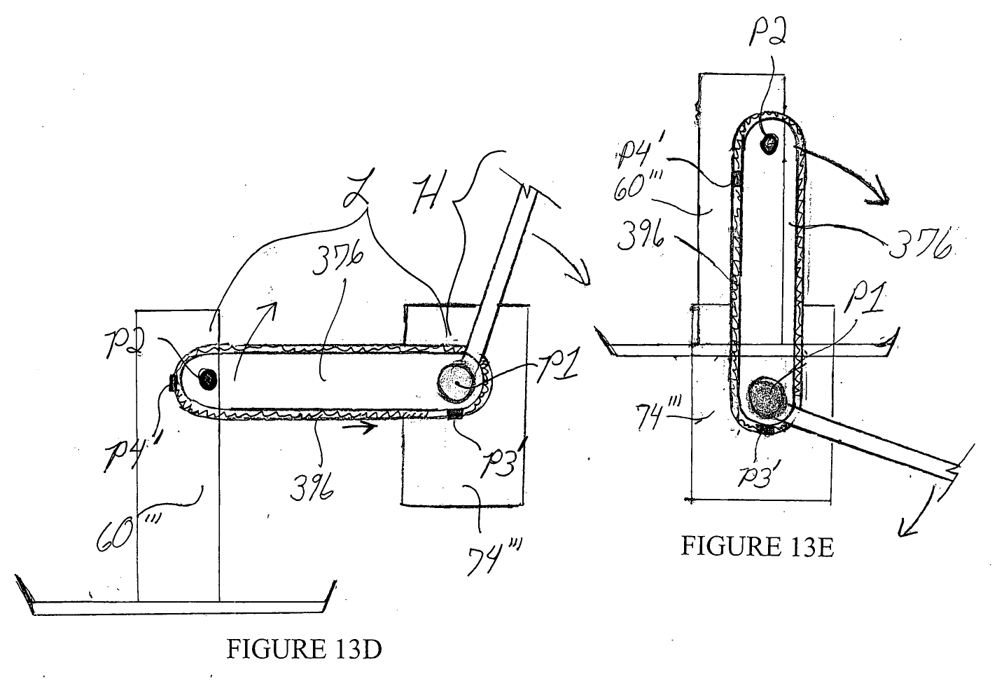

A schematic representation of the preferred lever system is shown in FIG. 13A, wherein the lever pivots at P1 relative to plate 74′, by force on handle portion H, with the parallel orientation arm 96 following. Alternatively, other guide member may be effective, such as those portrayed schematically in FIGS. 13B, 13C, and 13D and E, or others, but the inventor believes they will tend to be more complicated than the preferred orientation arm system.

In the alternative embodiment shown in FIG. 13B, a lever system is used to raise the rail assembly 20′, but the rail assembly 20′ is urged to say parallel to the ground by gravity rather than by an orientation/guide member. As the lift plate 176 is pivoted around P2, the rail assembly 20′ and its mount 60′ swing relative to the lift plate 176 due to gravity, and, assuming that the center of gravity of the rail assembly with loaded motorcycle is generally at the midpoint of the rail assembly (that is, midway along the rail's longitudinal dimension), then the rail assembly 20′ will tend stay generally parallel to the ground. However, this “unguided” or “uncontrolled” rail assembly orientation is less preferred, because sudden actions by the user, and/or uneven weight along the longitudinal dimension of the rail, could cause unpredictable and/or unsafe swinging of the rail assembly.

In the alternative embodiment shown in FIG. 13C, a lift plate 276 pivots at P1 relative to plate 74″. This embodiment uses gravity to keep the rail assembly 20″ generally parallel to the ground, but includes a slot S in the lift plate 276 in which a pin/peg 61 from the rail mount 60″ slides. This may not guide or control the swinging of the rail assembly in the vertical plane parallel to the tailgate of the pick-up, but it does guide and control the rail mount from movement forward or rearward, and, hence, helps prevent bending or damaging stresses on the axle at P2.

In the alternative embodiment shown in FIG. 13D, a chain or other linkage 396 is provided between the rail mount 60′″ and the plate 74′″, wherein the linkage 396 moves around lift plate 376 on a groove or other track on the outer perimeter of plate 376. The linkage 396 is pivotally connected at P3′ to plate 74 and pivotally connected to the rail mount at P4′. When the lift plate 376 is leveraged to pivot on its fulcrum (P1) from the position in FIG. 13D to that in FIG. 13E, for example, connection P3′ between plate 376 and the plate 74′″ moves linkage 396 around the outer perimeter of lift plate 376, so that connection P4′ between linkage 396 and the rail mount 60′″ pivots the rail mount to stay generally vertical. This system may be configured to keep the rail mount generally vertical throughout the lift. Various chains, gears, or other linkages may be designed to maintain the rail mount in its preferred orientation throughout lifting and lowering of the carried object and, hence, may be included in the broad term “guide member” or “orientation member.”

Lift arm 76 and orientation arm 96 are shown as square, tubular metal, which is well-adapted to be connected to, and pivot along the surface of, plate 74, while being strong and relatively light-weight because of their hollow structure. These arms, however, may be made of other shapes and structures, with the more important features being their lengths and relative positions and pivot points. The adjustable bracket 56 and rail mount 60 are shown as hollow, generally rectangular metal shapes, which is also well-adapted to cooperate with the arms (76, 96), while being strong and relatively light-weight because of their hollow structure. The bracket and mount, however, may also be of different shapes and structures besides those shown.

A preferred feature of the invented lifting and carrying device is that it preferably does not include any motor, screw lift or scissors jack, spring, or ratchet mechanism. The preferred embodiments do not require electricity or other sources of power besides the person using the device. The simple design of the preferred device provides a strong, simple apparatus that may be operated by one person in a safe manner. Also, the preferred device is easy to remove from the hitch and disassemble, and it is compact and convenient for storage. Preferably, the only moving parts are the lever being pulled (the lever being the lever arm plus the extension formed by the handle), which lifts the rail assembly and the orientation arm with it, and the rail assembly pivoting to stay parallel to the ground. No other moving parts are needed. An optional latch may be used and optional adjustment may be done to the hitch bracket (for example, for taller vehicles), but these are not considered by the inventor to be “moving parts” because they are not used, and not required for, loading and lifting the two-wheeled vehicle from the ground. Also, preferably, the only power used is the power of the user rolling the motorcycle onto the rail and the user pulling the lever (in loading and lifting the motorcycle), and pushing/holding the lever and then rolling the motorcycle back off the rail (in lowering and unloading the motorcycle).

Alternatively, the invented device could be adapted to lift and carry other objects, and, hence, the rail assembly 20 could be replaced with other object holders, such as a basket or other storage container, a rack for multiple bicycles, skis, snow-boards, surfboards, and/or other objects, etc. One may see from the foregoing Description and the Drawings that another object besides the rail assembly may be connected to the lever assembly and, hence, various objects, or containers or frames for carrying various objects, could be lifted up to the rear end or other side of the transport vehicle and carried thereon, preferably to a region starting at the level of the rear bumper and extending about three feet above the rear bumper. In some embodiments, an alternative attachment bracket may be used for connection to a part of a transport vehicle other than a hitch receiver, for example, at a side or a front of a bus rather than at the back of a truck.

Although this invention has been described above with reference to particular means, materials and embodiments, it is to be understood that the invention is not limited to these disclosed particulars, but extends instead to all equivalents within the scope of the following claims.

I claim:

1. A lift device for lifting and carrying an object on an outer side of a transport vehicle, the lift device comprising:
an attachment bracket for attaching the lift device to an outer side of the transport vehicle;
a holder assembly configured to receive said object to be lifted and carried;
a lever assembly connecting the holder assembly to the attachment bracket, the lift assembly comprising:
a lever having a first end and a second end, an elongated handle portion near the first end and a lift portion near the second end;
the lever being pivotally connected to said attachment bracket at a first pivot point between said lift portion and said elongated handle portion;
said lift portion being pivotally connected to said holder at a second pivot point near said second end; and
wherein the elongated handle portion extends out from the first pivot point a distance of greater than two feet and is configured to be manually pulled or pushed by a user to pivot the lever on said first pivot point to raise said holder assembly from a lowered position to a raised position.

2. A lift device as in claim 1 comprising no motor.

3. A lift device as in claim 1 comprising no screw jack and no scissors jack.

4. A lift device as in claim 1, wherein the handle portion has a bend in the range of 20-60 degrees.

5. A lift device as in claim 1, wherein the handle portion comprises a disconnectable joint between a first part and a second part of the handle portion, so that the first part of the handle portion is removable for storage.

6. A lift device as in claim 5, wherein said detachable joint connects said first part to said second part at 20-60 degrees to the second part.

7. A lift device as in claim 6, wherein said detachable joint comprises a sleeve into which the first part slides.

8. A lift device as in claim 1, wherein the holder assembly comprises:
an elongated rail that is generally horizontal when the holder assembly is in the lowered position and that has a floor and sidewalls configured to receive front and rear wheels of a two-wheeled vehicle; and
the lift device further comprising a guide member pivotally mounted to both the attachment bracket and the holder assembly and configured to maintain the elongated rail generally horizontal throughout lifting the holder assembly from the lowered position to the raised position.

9. A lift device as in claim 9, wherein the guide member is an elongated arm that is parallel to the lift portion, and that remains parallel to the lift portion throughout the holder assembly being lifted from the lowered position to the raised position.

10. A lift device as in claim 1, further comprising a hitch receiver adapted for connection to the transport vehicle, wherein the attachment bracket is received in and secured inside the hitch receiver.

11. A lift device for lifting and carrying a two-wheeled vehicle on an outer side of a transport vehicle, the lift device comprising:
an attachment assembly configured to attach to an outer side of a transport vehicle;
a rail assembly having an elongated, generally horizontal rail for receiving and supporting a two-wheeled vehicle;
a lever assembly connecting the rail assembly to the attachment assembly, the lever assembly comprising:
a lift member having a first end and a second end, the lift member being pivotally connected to said attachment assembly at a first pivot point between said first end and said second end and nearer said first end, and the lift member being pivotally connected to said rail assembly at a second pivot point at or near said second end; and
an elongated handle rigidly connected to said lift member between the first pivot point and said first end;
wherein the elongated handle extends out from the lift member a distance of greater than two feet and is configured to be manually pulled or pushed by a user to pivot the lift member on said first pivot point to raise said rail assembly from a lowered position to a raised position; and
wherein the rail remains generally horizontal in said lowered position, in said raised position, and when being lifted between said lowered and raised positions.

12. A lift device as in claim 11, wherein the lift member is an elongated bar.

13. A lift device as in claim 11, wherein the lift member is a plate.

14. A lift device as in claim 11, further comprising an orientation member connected to the rail assembly and to the attachment assembly and that is configured to maintain the rail in said generally horizontal orientation.

15. A lift device as in claim 14, wherein the orientation member is an elongated bar that is pivotally connected to the rail assembly and pivotally connected to the attachment assembly.

16. A lift device as in claim 15, wherein the orientation member is parallel to the lift member.

17. A lift device as in claim 11, wherein the rail comprises an elongated horizontal floor, elongated sidewalls on two sides of the floor, and a wheel retainer extending vertical upwards from the floor.

18. A lift device as in claim 11, wherein the elongated handle is removably connected to the lift member at an angle of 20-60 degrees to a longitudinal axis of the lift member between said first pivot point and said second pivot point.

20. A lift device as in claim 11, comprising no motor and no jack.
